(19) United States
(12) Patent Application Publication
(10) Pub. No.: US 2013/0024807 A1
(43) Pub. Date: Jan. 24, 2013

(54) MOBILE ELECTRONIC DEVICE

(71) Applicants: Hiroki KOBAYASHI, Daito-shi (JP); Yoshihiko Hinoue, Osaka (JP)

(72) Inventors: Hiroki KOBAYASHI, Daito-shi (JP); Yoshihiko Hinoue, Osaka (JP)

(21) Appl. No.: 13/358,675

(22) Filed: Jan. 26, 2012

(30) Foreign Application Priority Data
Jan. 26, 2011 (JP) JP2011-014095

(51) Int. Cl. G06F 3/048

(52) U.S. Cl. 715/781

(57) ABSTRACT

A mobile terminal device and methods are disclosed. An image and text data associated with the image are stored, and a display module comprising a first display area and a second display area different from the first display area is controlled. An input to select the image is received providing a selected image, and the text data is displayed on the second display area, when a thumbnail image of the selected image is displayed on the first display area.

### CROSS-REFERENCE TO RELATED APPLICATION

The present application claims priority under 35 U.S.C. §119 to Japanese Patent Application No 2011-014095, filed on Jan. 26, 2011, entitled “MOBILE TERMINAL DEVICE”. The content of which is incorporated by reference herein in its entirety.

### FIELD

Embodiments of the present disclosure relate generally to mobile electronic devices, and more particularly relate to mobile electronic devices operable to handle thumbnail images.

### BACKGROUND

Some conventional mobile electronic devices have a function for reducing a plurality of videos into respective thumbnail images and displaying a list including the thumbnail images. If a user selects one of the thumbnail images, a video corresponding to the selected thumbnail image may be played. The user may create a playlist, in which the selected thumbnail images line up in a sequence to be played, by selecting thumbnail images and setting up an order in which the videos may be played. The playlist may be displayed on a displayed screen; however, a large data processing capacity may be required for creating the playlist. The large data processing capacity can put a great burden for creating such a playlist on processors of the mobile electronic devices.

### SUMMARY

A mobile terminal device and methods are disclosed. An image and text data associated with the image are stored, and a display module comprising a first display area and a second display area different from the first display area is controlled. An input to select the image is received, and the text data is displayed on the second display area, when a selected thumbnail image of the image selected by the input is displayed on the first display area In this manner, a playlist can be set up with a text data. Thereby, a processor bears less burden to process the text data compared to a case in which the playlist is set up with a thumbnail image.

In an embodiment, a mobile terminal device comprises a display module, a memory module, a receiving module, and a display control module. The display module comprises a first display area and a second display area different from the first display area. The memory module stores an image and text data associated with the image. The receiving module receives an input to select the image. The display control module controls the display module such that, when a selected thumbnail image of the image selected by the input is displayed on the first display area, the text data associated with the selected thumbnail image is displayed on the second display area.

In another embodiment, a method for operating a mobile terminal device stores an image and text data associated with the image, and controls a display module comprising a first display area and a second display area different from the first display area to display the image and the text data. The method further receives an input to select the image to provide a selected image, and displays the text data on the second display area, when a selected thumbnail image of the selected mage is displayed on the first display area.

In a further embodiment, a computer readable storage medium comprising computer-executable instructions for operating a mobile terminal device. The method executed by the computer-executable instructions stores an image and text data associated with the image, and controls a display module comprising a first display area and a second display area different from the first display area to display the image and the text data. The method executed by the computer-executable instructions further receives an input to select the image providing a selected image, and displays the text data on the second display area, when a selected thumbnail image of the selected image is displayed on the first display area.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of an exploded perspective view of an exemplary mobile phone according to an embodiment of the disclosure.

FIGS. 2(a) to 2(d) are illustrations of the mobile phone shown in FIG. 1 showing a switching operation from a closed state to an open state according to an embodiment of the disclosure.

FIG. 3 is an illustration of an exemplary schematic functional block diagram of a mobile phone according to an embodiment of the disclosure.

FIG. 4A is an illustration of exemplary display screens displaying a search screen and a keyboard screen according to an embodiment of the disclosure.

FIG. 4B is an illustration of exemplary display screens displaying a list of the search result according to an embodiment of the disclosure.

FIGS. 5A and 5B are illustrations of exemplary display screens for playing a video in a playlist according to an embodiment of the disclosure.

FIG. 6 is an illustration of an exemplary flowchart showing a process for playing a video according to an embodiment of the disclosure.

FIG. 7 is an illustration of exemplary display screens for playing a video in a playlist according to an embodiment of the disclosure.

FIGS. 8A to 8D are illustrations of exemplary marks according to an embodiment of the disclosure.

### DETAILED DESCRIPTION

The following description is presented to enable, a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistances (PDAs), personal handy phone systems (PHSs), lap top computers, Televisions (TVs), Global Positioning Systems (GPSs) or navigation systems, health equipments, or other electronic device operable to process image, text, and/or voice data. As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

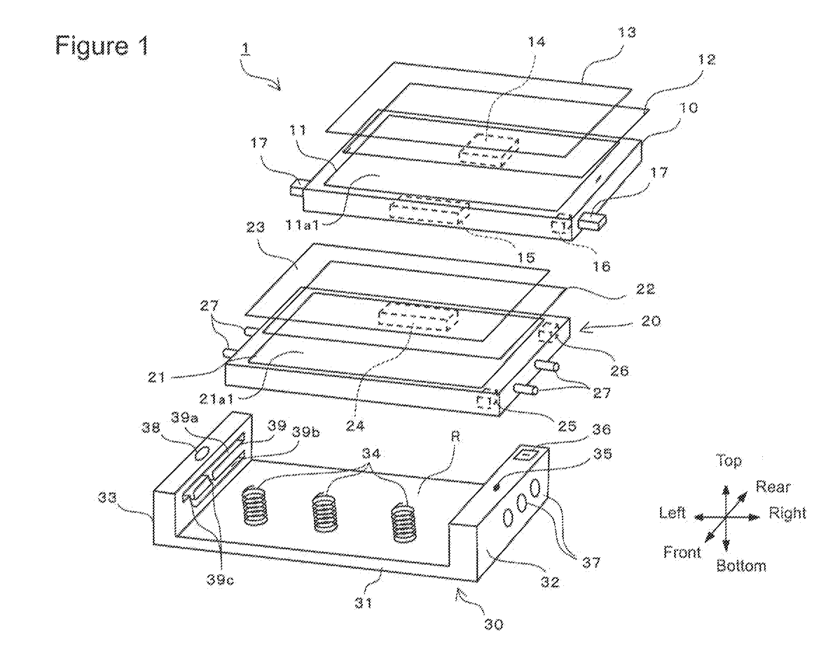

FIG. 1 is an illustration of an exploded perspective view of a mobile phone 1 according to an embodiment of the disclosure. The mobile phone 1 includes a first cabinet 10, a second cabinet 20, and a supporter 30 that holds the first cabinet 10 and the second cabinet 20.

The first cabinet 10 has a horizontally long and cuboid shape. The first cabinet 10 includes a first touch panel. The first touch panel includes a first display 11, a first touch sensor 12, and a first transparent cover 13.

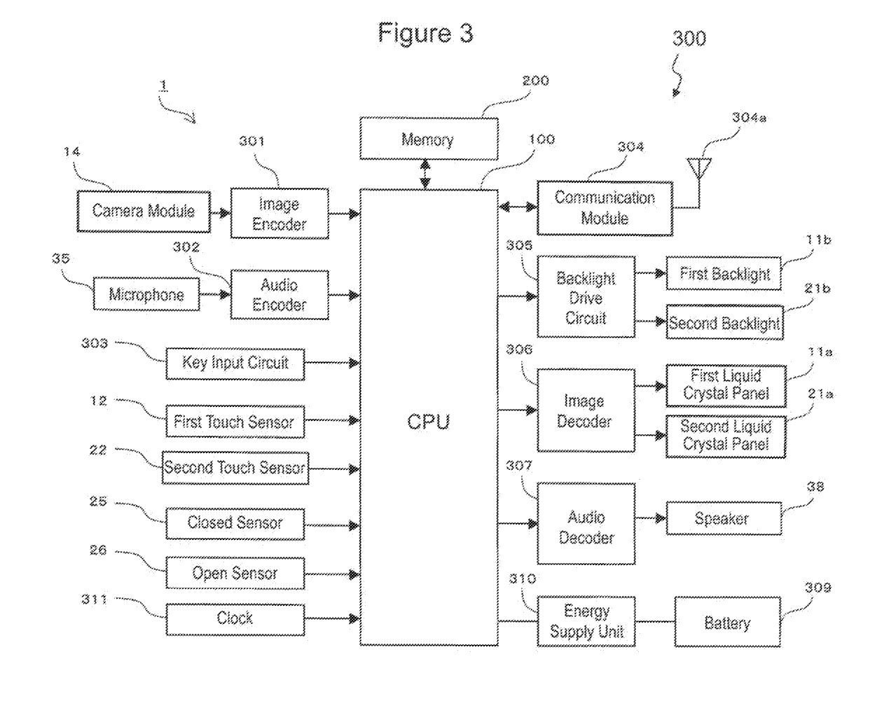

The first display 11 corresponds to a first display module of a display module and displays an image on the first display screen 11a1. The first display 11 includes a first liquid crystal panel 11a and a first backlight 11b (FIG. 3) that illuminates the first liquid crystal panel 11a. The first display screen 11a1 is located in front of the first liquid crystal panel 11a. The first touch sensor 12 is overlaid on top of the first display 11. The first backlight 11b includes one or more light sources.

The first touch sensor 12 corresponds to a first receiving module that receives an input to the first display 11. The first touch sensor 12 may be a transparent, rectangular sheet, and may cover the first, display screen 11a1 of the first display 11. The first touch sensor 12 includes a first transparent electrode and a second transparent electrode arranged in a matrix configuration. The first touch sensor 12 can detect a location on the first display screen 11a 1 where a user touches and outputs location signals corresponding to the location by detecting the change of capacitance between these transparent electrodes. A user touching the first display screen 11a1 refers to, for example, a user placing a touching object such as, but without limitation, a pen, a finger, or other object, on or above the first display screen 11a1. The touching object or the finger may stand still or be moving on or above the first display screen 11a1. In addition, touching the first display screen 11a1, in fact, refers to touching the area where an image is displayed on the first transparent cover 13, which is described subsequently.

The first transparent cover 13 is overlaid on top of the first touch sensor 12. The first transparent cover 13 may cover the first touch sensor 12 and appear in front of the first cabinet 10.

The first cabinet 10 may include a camera module 14 in the middle and slightly toward the rear position of the inside thereof. The first cabinet 10 may also include a lens window (not shown in the figure) to take in a subject image in this camera module 14 on the bottom surface thereof. The first cabinet 10 may include a magnet 15 in the middle position in a vicinity of a front surface thereof, and a magnet 16 at a right front corner thereof.

The first cabinet includes a first protruding member 17a on a right side and a second protruding member 17b on a left side of the first cabinet 10.

The second cabinet 20 may have a horizontally long and cuboid shape and have nearly the same shape and the size of the first cabinet 10. The second cabinet 20 may include a second touch panel. The second touch panel may also include a second display 21, a second touch sensor 22 and a second transparent cover 23.

The second display 21 corresponds to a second display module of the display module and displays an image on a second display screen 21a1. The second display 21 includes a second liquid crystal panel 21a and a second backlight 21b that illuminates the second liquid crystal panel 21a. The second display screen 21a1 is located in front of the second liquid crystal panel 21a. The second backlight 21b includes one or a plurality of light sources. The first display 11 and the second display 21 may include a display element such as an organic electro luminous (EL) panel.

The second touch sensor 22 corresponds to a second receiving module that receives an input to the second display 21. The second touch sensor 22 is overlaid on the second display 21. The second touch sensor 22 may cover the second display 21, and the second transparent cover 23 may be overlaid on top of the touch sensor 22. A configuration of the second touch sensor 22 is same as that of the first touch sensor 12. A, user touching the second display screen 21a1 refers to a user touching an area in which an image is displayed on the second transparent cover 23, with an object, such as but without limitation, a pen, a finger, or other object, as, explained below.

The second transparent cover 23 may cover the second touch sensor 22 and appears in front of the second cabinet 20.

The second cabinet 20 may include a magnet 24 in a middle position in a vicinity of a rear surface thereof. The magnet 24 and the magnet 15 in the first cabinet 10 are configured to attract to each other in an open state. If either the magnet 24 or the magnet 15 has a magnetic force with enough strength, the other magnet may be replaced with a magnetic substance.

In the second cabinet 20, a closed sensor 25 is arranged at a right front corner, and an open sensor 26 is arranged at a right rear corner. The sensors 25 and 26 each include, for example but without limitation, a Hall effect integrated circuit (IC), or other sensor, that responds to the magnetic force of the magnet 16, and outputs detectable signals. In the closed state, the magnet 16 in the first cabinet 10 approaches closely to the closed sensor 25, and as a result, the closed sensor 25 outputs ON signals. On the other hand, in the open state, the magnet 16 in the first cabinet 10 approaches closely to the open sensor 26, and as a result, the open sensor 26 outputs ON signals.

Moreover, the second cabinet 20 includes two shanks 27 respectively at both sides thereof. The supporter 30 includes a base plate module 31, a right holding module 32 located at a right edge of the base plate module 31, a left holding module 33 located at a left, edge of the base plate module 31. The supporter 30 also includes a housing area R which is surrounded by the base plate module 31, the right holding module 32, and the left holding module 33.

On the base plate module 31, three coil springs 34 are horizontally arranged side by side in a direction from right to left. Since the second cabinet 20 is fixed in the supporter 30, these coil springs 34 come in contact with the bottom surface of the second cabinet 20 and provide the force to push the second cabinet 20 upward.

A microphone 35 and a power key 36 are located on the top surface of the right holding module 32. A speaker 38 is located on the top surface of the left holding module 33.

In addition, a plurality of hard keys 37 is located on the outside side surface of the right holding module 32. The right holding module 32 includes guide grooves 39 on the inside surfaces thereof as illustrated in FIG. 1 and the left holding module 33 includes guide grooves 39 (not shown in FIG. 1). The guide grooves 39 may include an upper groove 39a, a lower groove 39b, and two vertical grooves 39c. The upper groove 39a and the lower groove 39b are extended in a longitudinal direction or in a direction from front to rear, and the vertical grooves 39c are extended in the vertical direction or in a direction from top to bottom for connecting the upper groove 39a and the lower groove 39b.

When the mobile phone 1 is assembled, the shanks 27 are inserted into the lower grooves 39b, and the second cabinet 20 is housed in the housing area R of the supporter 30. The first and second protruding members 17a and 17b are inserted into the upper grooves 39a of the guide grooves 39. The first cabinet 10 is disposed on top of the second cabinet 20 and housed in the housing area R of the supporter 30.

Thus, the first cabinet 10 and the second cabinet 20 are housed one above the other in the housing area R surrounded, by the base plate module 31, the right holding module 32, and the left holding module 33. In this configuration, the first cabinet 10 may slide back and forth guided by the upper grooves 39a. The second cabinet 20 can slide back and forth guided by the lower grooves 39b. When the second cabinet 20 moves forward and the shanks 27 reach to the vertical grooves 39c, the second cabinet 20 may slide up and down guided by the vertical grooves 39c.

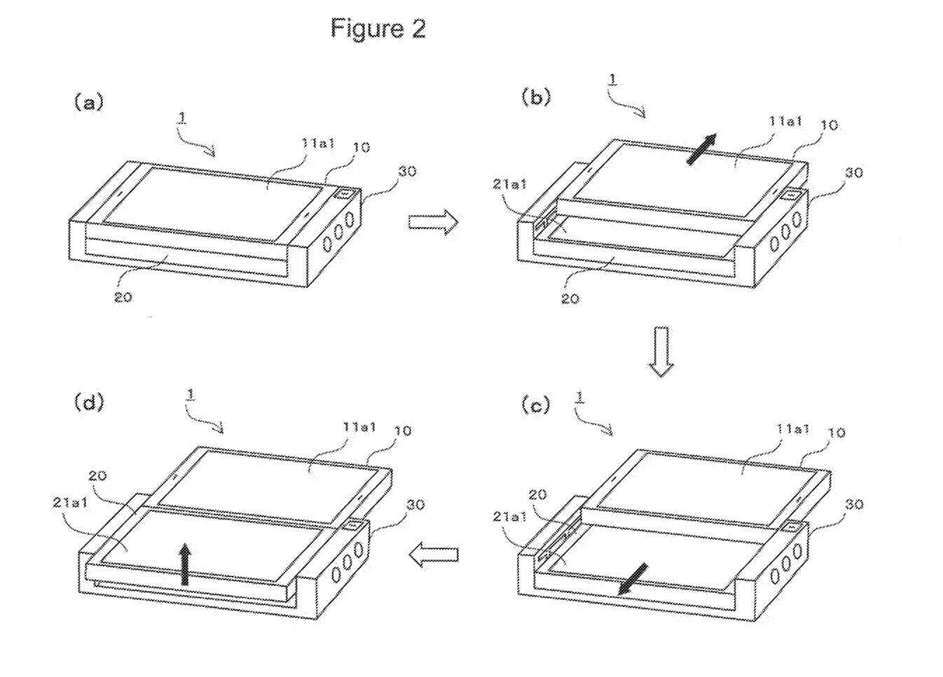

FIG. 2 is an illustration of the mobile phone 1 shown in FIG. 1 showing a switching operation from a closed state 2(a) to an open state 2(d) according to an embodiment of the disclosure.

In the closed state shown in FIG. 2(a), the first cabinet 10 is superimposed on top of the second cabinet 20, and the mobile phone 1 is folded. The second display screen 21a1 is hidden behind the first cabinet 10, and the first display screen 11a1 alone is exposed outside.

The first cabinet 10 moves backward in a direction of an arrow shown in FIG. 2(b), and the second cabinet 20 is, pulled forward in the direction of an arrow shown in FIG. 2(c). When the second cabinet 20 no longer substantially completely overlaps with the first cabinet 10, the shanks 27 shown in FIG. 1 reach the vertical grooves 39c. Hence, the shanks 27 move along the vertical grooves 39c, and the second cabinet 20 is able to move up and down. At this time, the second cabinet 20 moves upward due to the elastic force of the coil springs 34 and the attracting force of the magnet 15 and the magnet 24.

As illustrated in FIG. 2(d), the first cabinet 10 and the second cabinet 20 are aligned and in contact with each other, and the first display screen 11a1 of the first cabinet 10 becomes as high as the second display screen 21a1 of the second cabinet 20. Thus, the mobile phone 1 is switched to the open state. In the open state, the first cabinet 10 and the second cabinet 20 are expanded, and both the first display screen 11a1 and the second display screen 21a1 are exposed outside.

FIG. 3 is an illustration of a schematic functional block diagram 300 (system 300) of the mobile phone 1 according to an embodiment of the disclosure. The system 300 may include a CPU 100, a memory 200, an image encoder 301, an audio encoder 302, a key input circuit 303, a communication module 304, a backlight drive circuit 305, an image decoder 306, an audio decoder 307, a battery 309, energy supply unit 310 (power supply module 310), and a dock 311.

The camera module 14 may include an image sensor such as a charge-coupled device (CCD). The camera module 14 digitalizes imaging signals output from the image sensor, performs various corrections for the imaging signals, such as a gamma correction, and outputs the corrected imaging signals to the image encoder 301.

The image encoder 301 performs an encoding process on the imaging signals from the camera module 14 and outputs encoded imaging signals to the CPU 100.

The microphone 35 converts collected sounds into audio signals and outputs converted collected sounds to the audio encoder 302.

The audio encoder 302 converts the analog audio signals from the microphone 35 into the digital audio signals while performing the encoding process on the digital audio signals and outputting encoded digital audio signals to the CPU 100.

If a power, key 36 or one of hard keys 37 is pressed, the key input circuit 303 outputs an input signal corresponding to each key to the CPU 100.

The communication module 304 converts data from the CPU 100 into wireless signals and transmits the wireless signals to base stations through an antenna 304a. The communication module 304 also converts wireless signals received through the antenna 304a into data and outputs the data to the CPU 100.

The backlight drive circuit 305 applies the voltage corresponding to the control signals from the CPU 100 to the first backlight 11b and the second backlight 21b. The first backlight 11b is lit up due to the voltage by the backlight drive circuit 305 and illuminates the first liquid crystal panel 11a. The second backlight 21b is lit up due to the voltage by the backlight drive circuit 305 and illuminates the second liquid crystal panel 21a.

The image decoder 306 converts image data from the CPU 100 into image signals that may be displayed on the first liquid crystal panel 11a and on the second liquid crystal panel 21a, and outputs the image signals to the liquid crystal panels 11a and 21a. The first liquid crystal panel 11a displays images corresponding to the image signals on the first display screen 11a1. The second liquid crystal panel 21a displays images corresponding to the image signals on the second display screen 21a1.

The audio decoder 307 performs decoding process on audio signals from the CPU 100 and sound signals of various notification sounds, such as a ringtone or an alarm sound, and it converts them to analog audio signals and output them to the speaker 38. The speaker 38 plays the audio signals and/or ringtones from the audio decoder 307.

The battery 309 can provide electric power to the CPU 100 and/or each component other than the CPU 100 and includes a secondary cell. The battery 309 is connected to the power supply module 310.

The power supply module 310 converts the voltage of the battery 309 into the voltage level that each component requires and provides thus converted voltage to each component. The power supply module 310 can provide electric power from an external power source (not shown) to the battery 309 and charges the battery 309.

The clock 311 measures time and outputs the signals corresponding to the measured time to the CPU 100.

The memory 200, may be realized as a non-volatile storage device (non-volatile semiconductor memory, hard disk device, optical disk device, and the like), a random access storage device (for example, SRAM, DRAM), or any other form of storage medium known in the art. The memory 200 may be coupled to the CPU 100 respectively such that the CPU 100 can read information from, and write information to the memory 200.

As an example, the CPU 100 and the memory 200, may reside in their respective ASICs. The memory 200 may be integrated into the CPU 100. In an embodiment, the memory 200 may include a cache memory, for storing temporary variables or other intermediate information during execution of instructions to be executed by the CPU 100. The memory 200 may also include non-volatile memory for storing instructions to be executed by the CPU 100.

The memory 200 stores, for example but without limitation, image data taken by the camera module 14, data imported externally through the communication module 304, data entered by respective touch sensors 12 and 22 as a predefined file format, or other data. The images taken by the camera module 14 may include, for example but without limitation, a still image such as, a picture, a moving image such as a video or a movie, or other image. The memory 200 may also store, for example but without limitation, a computer program that is executed by the CPU 100 respectively, an operating system, an application program, tentative data used in executing a program processing, or other application.

The memory 200 also stores display data. The display data comprises, for example but without limitation, data that coordinates a content of an image to be displayed on the respective display screens 11a1 and 21a1 with a location where each image is displayed on the respective display screens 11a1 and 21a1, or other data. The images include, for example but without limitation, a still image, a video, or other image. A video includes a plurality of frames, and each frame is constituted with a still image. Still images include an icon, a button, a picture, a thumbnail image, a text layout area, or other still image. The text layout area is the area where text data is displayed. A video, the thumbnail image of the video, the detailed information of the video, and the play item described later are linked by the identification data of the video and are stored in the memory 200.

The CPU 100 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like.

A processor may also be implemented as a combination of computing devices, e.g., a combination of a digital signal processor and a microprocessor, a plurality of microprocessors, one or more microprocessors in conjunction with a digital signal processor core, or any other such configuration. In practice, the CPU 100 comprise processing logic that is configured to carry out the functions, techniques, and processing tasks associated with the operation of the system 300.

In particular, the processing logic is configured to support the method for operating a mobile terminal device described herein. Furthermore, the steps of a method or algorithm described in connection with the embodiments disclosed herein may be embodied directly in hardware, in firmware, in a software module executed by CPU 100, or in any practical combination thereof. The CPU 100 operates the camera module 14, the microphone 35, the communication module 304, the liquid crystal panels 11a and 21a, and the speaker 38 based on the operation input signals from the key input circuit 303, and the respective touch sensors 12 and 22 in accordance with the control program. Thus, the CPU 100 executes various applications, such as a phone call function, an e-mail function, a key-lock function, or other function.

The CPU 100 searches a video as a searching module and takes in the information of the search result. Specifically, the CPU 100 transmits the information, such as a keyword entered by a user, to the distribution source of the video, for example, to the specific server, by the communication module 304. Hence, the video containing the information in the attribution is retrieved, and the CPU 100 receives the video data of the search result through the communication module 304. The video data includes image data, audio data and accompanying data and a plurality of frames constitutes the image data. In this regard, however, a part of the video data is obtained as the search result. For example, of image data, only a frame and an accompanying data are taken in.

The accompanying data includes, for example but without limitation, the information indicating the image in detail, such as a title of the image, a comment, a shooting date and time, a posting date and time, a name of the person who takes images, a contributor, a volume of data, a playback time, or other information. Identification information of the video is also attached to the image data, audio data, and the accompanying data of the video, and it coordinates the image data, the audio data, and the accompanying data, or other data.

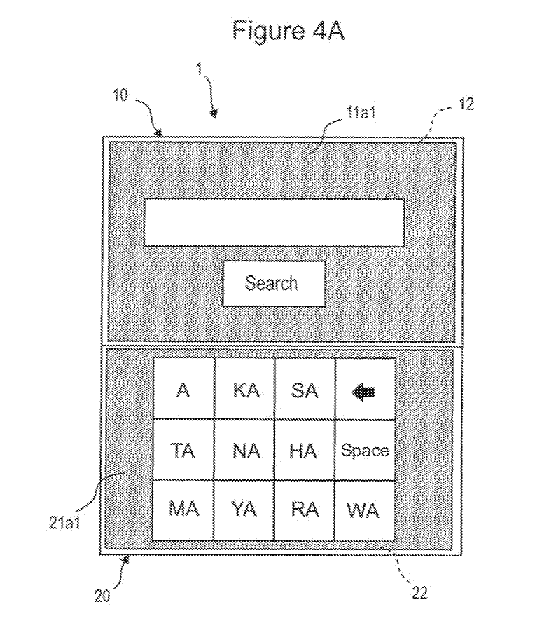

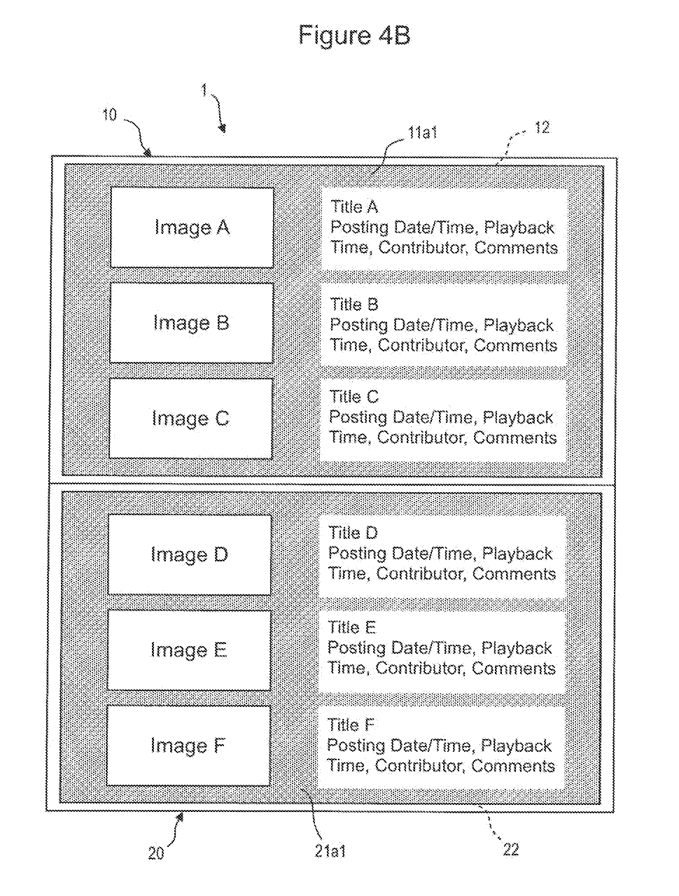

The CPU 100 refers to the display data and determines the image selected by a user according to the input location on the respective touch sensors 12 and 22. For example, when a user touches a button for an input key shown in FIG. 4A, the input key displayed at the touched input location is identified based on the display data. Thus, the input key is selected, and it is determined that the letter that the input key indicates is entered. In addition, when a user touches an area on the thumbnail image, “Image A,” of the video A shown in FIG. 4B, for example, the CPU 100 identifies the thumbnail image, “Image A,” displayed at the input location. Thus, it is determined that the thumbnail image, “Image A,” and the corresponding the video A are selected, and at the same time, the detailed information of the video A associated with the thumbnail image is obtained.

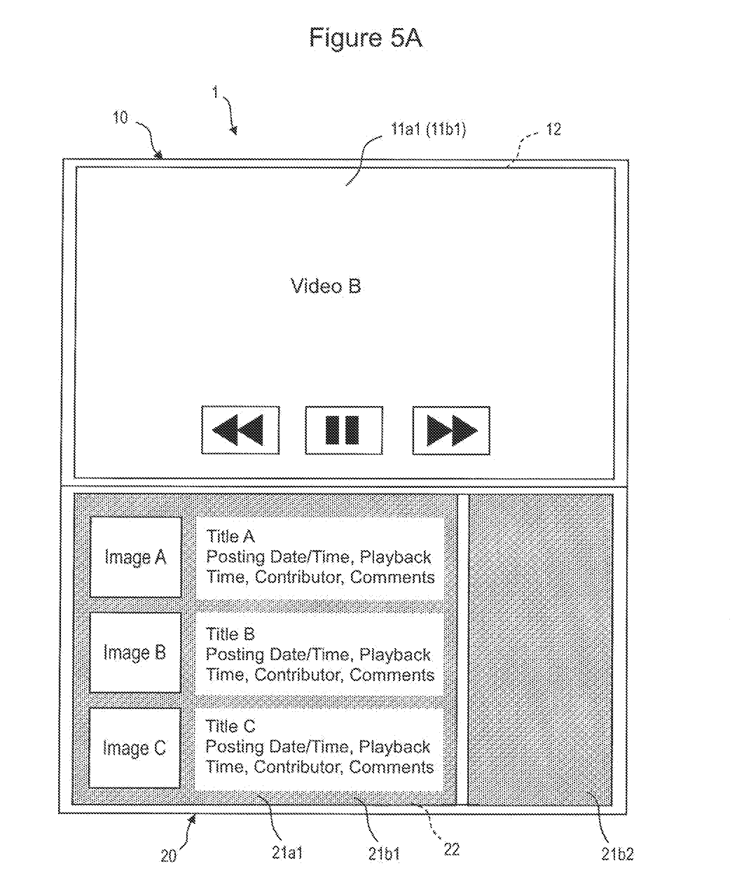

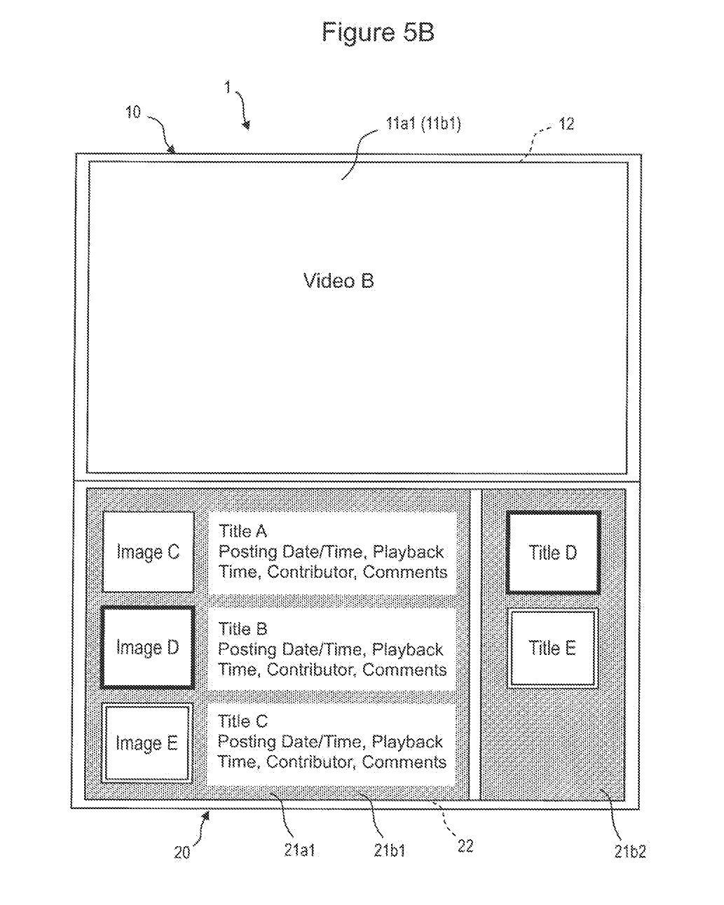

The CPU 100, as an extracting module, extracts a part of or all of a text data from the accompanying data of the selected video and obtains the identification information of the video from the accompanying data of the video. Specifically, as illustrated in FIG. 5B, when the thumbnail image, “Image D,” of the video D is selected, the CPU 100 extracts the title name; “Title D,” from the detailed information of the video D. The identification information of the video is attached to the extracted data. Because the extracted text data is the data to identify the video, it is used for the play items of the video described subsequently.

The CPU 100, as a display control module, outputs control signals to the image decoder 306 and the backlight drive circuit 305. For example, the CPU 100 controls the backlight drive circuit 305 and turns off the respective backlights 11b and 21b. On the other hand, the CPU 100 lights up the respective backlights 11b and 21b, controls the image decoder 306, and displays an image on the respective display screens 11a1 and 21a1. In addition, the CPU 100 controls contrast brightness, a screen size, and transparency of the screen when it displays the image.

In this manner, the display control module (CPU 100) controls the display module such that, when a selected thumbnail image of the image selected by the input and the text data associated with the selected thumbnail image are displayed on one or more display screens.

For example, in an embodiment as illustrated in FIG. 4B, a search result list, which includes thumbnail images and text data associated with the thumbnail image, of a video is displayed on both first and second display screens 11a1 and 21a1. In another embodiment as illustrated in FIG. 5A, the second display screen 21a1 includes a first display area 21ba and a second display area 21b2 while the first display screen 11a1 includes a third display area 11b1, and a search result list of the video is displayed on the first display area 21b1.

FIG. 4A is an illustration of exemplary display screens displaying a search screen and a keyboard screen and FIG. 4B is an illustration of exemplary display screens displaying a list of the search result according to an embodiment of the disclosure. FIGS. 5A and 5B are illustrations of exemplary display screens displaying for playing a video in the playlist according to an embodiment of the disclosure.

The search result list of the video includes thumbnail images and detailed information. A thumbnail image is constituted with an image that a frame is shrunk and displayed based on the image data of the video, and the thumbnail image is displayed in a smaller size than the video. The detailed information is constituted with a text layout area in which a part or all of the accompanying data of the video is entered. Laid side by side, the thumbnail image and the detailed information in pair indicate a video.

In an embodiment illustrated in FIG. 5B, the playlist is displayed in the second display area 21b2 on the second display screen 21a1 while the search result list is displayed in the first display area 21b1. The second display area 21b2 corresponds to a playlist section in which a playlist is created. The playlist may include one or more play items. The play item may include texts, images shown in the search result list, the images and the texts together, or the like. For example, the play item includes text data (titles) extracted by the extracting module is entered, as illustrated in FIG. 5B. The play items can be arranged in any order. In one embodiment, the play items may be arranged in the order of the videos to be played. The order of the play items lining up may correspond to the order in which a user selects thumbnail images. In addition, if a user performs an operation of moving the location where a play item is displayed, a display location of the play item may also be moved. Hence, the order of the play items is changed, and the order of the videos to be played is also changed.

The display control module further allows the display module to display respectively a mark to the text data and the selected thumbnail image corresponding to the text data for indicating that the text data and the selected thumbnail image may be associated with each other. Therefore, the thumbnail images in the search result list and the play items in the playlist may be associated and displayed. For example, when the video corresponding to the thumbnail image is selected as a target to be played, a same mark is attached to the play item and the thumbnail image of the video.

The mark may be, for example but without a limitation, a unified frame color and/or shape of both the thumbnail image and the play item. Also, the same mark may be attached to the thumbnail image and the play item. Specifically, as illustrated in FIG. 5B, when the video D corresponding to the thumbnail image, “Image D,” is listed as the play item, “Title D,” the frames of the thumbnail image and the play item are indicated by the heavy lines with the same width. When the video E corresponding to the thumbnail image, “Image E,” is listed as the play item, “Title E,” the frames of the thumbnail image and the play item are indicated by the same double lines.

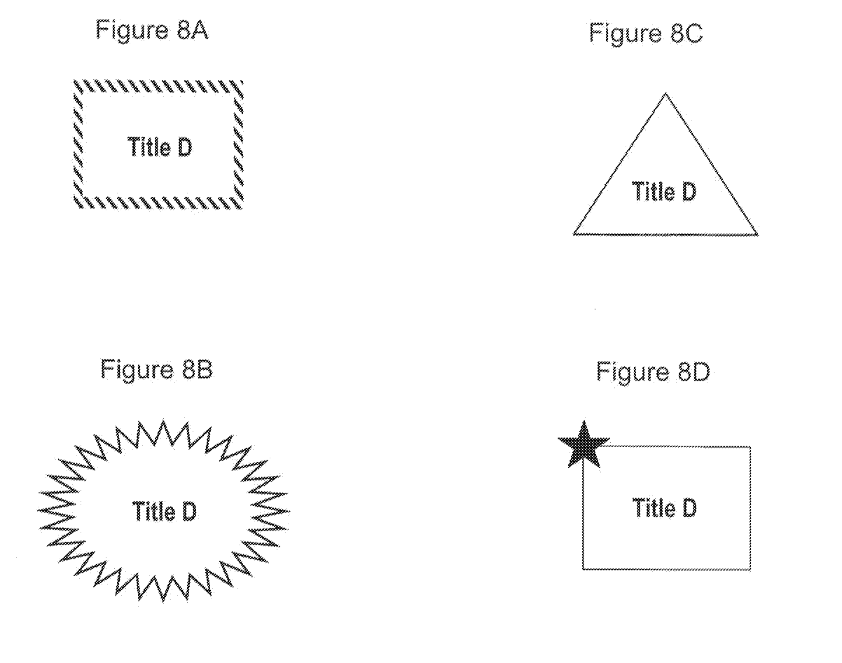

Additionally, a mark may be formed, for example, in terms of frames of a thumbnail image and a play item, by making a pattern in a line, such as diagonal lines shown in FIG. 8A, a form of a line, such as a zigzag line shown in FIG. 8B, or a shape of a frame, such as a triangular shape shown in FIG. 8C. Moreover, a mark may be formed as illustrated in FIG. 8D, by attaching a graphic, such as a star, to frames of the thumbnail image and the corresponding play item, they become marks for the thumbnail image and the play item.

Moreover, as illustrated in FIG. 5A and FIG. 5B, the video may be displayed in a larger size than the thumbnail image in the third display area 11b1 on the first display screen 11a 1. The video can be played by the continuous display of video frames. The video may be played either in the order of the playlist or in the order in which a user individually selects. When the video is listed as a play item, before or when it is played, the identification information of the video corresponding to the play item is transmitted to the distribution source of the video in the order of the play items through the communication module 304.

Accordingly, the image data and the play data of the video corresponding to the identification information are downloaded from the distribution source, and the image is displayed on the first display screen 11a1 based on the image data. A fast-forward button, a pause button, and a rewind button are displayed on the video. These buttons are displayed for a predetermined time both after the video is started to play and after an operation is performed by a user.

The CPU 100 outputs a sound from the speaker 308 based on the audio data by synchronizing the audio data with the display of the image. Thus, the video is played.

In FIG. 4A, a screen for searching a video is displayed on the first and second display screens 11a1 and 21a1. The first display screen 11a1 displays a text area to be input and The second display screen 21a1 displays a keyboard. In FIG. 4B, a search result list of a video is displayed on the first and second display screens 11a1 and 21a1. In FIGS. 5A and 5B, a video is displayed in the third display area of on the first display screen 11a1, while a search result list is displayed in the first display area 21b1 on the second display screen 21a1 and the playlist is displayed in the second display area 21b2 on the second display screen 21a1.

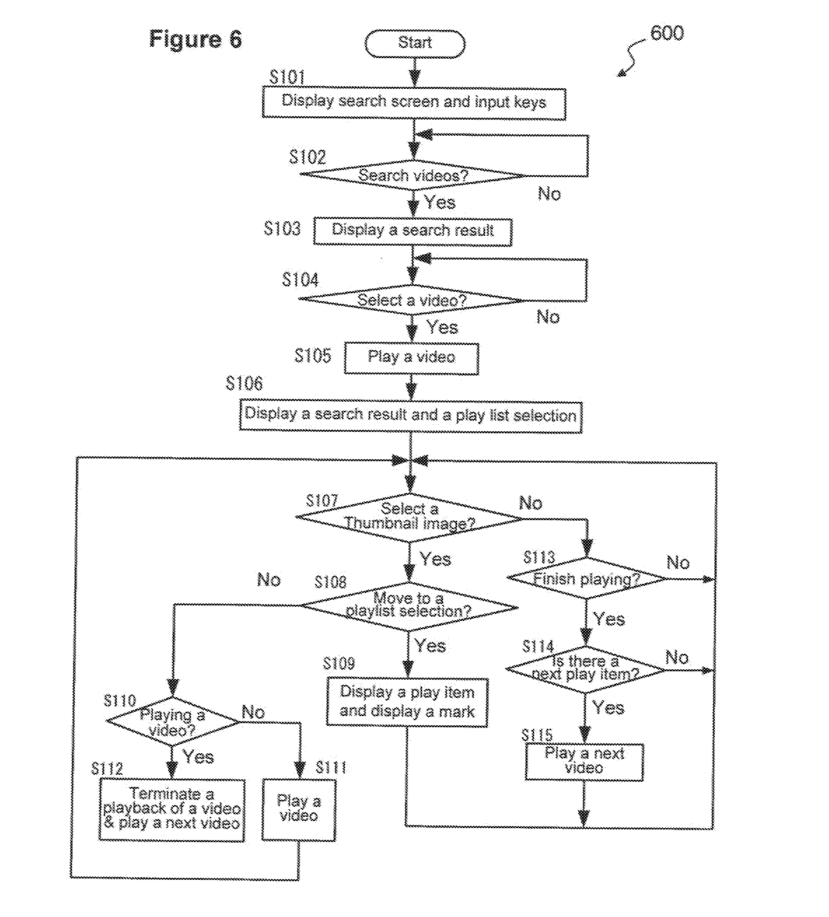

FIG. 6 is an illustration of an exemplary flowchart showing a process for playing a video according to an embodiment of the disclosure. The various tasks performed in connection with the process 600 may be performed by software, hardware, firmware, a computer-readable medium having computer executable instructions for performing the process method, or any combination thereof. The process 600 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein. In practical embodiments, portions of the process 600 may be performed by different elements of the systems 300 such as the CPU 100, the memory 200, the image encoder 301, the audio encoder 302, the key input circuit 303, the communication module 304, the backlight drive circuit 305, the video decoder 306, the audio decoder 307, the battery 309, the energy supply module 310, the clock 311, the first liquid crystal panel 11a, the first touch sensor 12, the second liquid crystal panel 21a, the second touch, sensor 22, etc. Process 600 may have functions, material, and structures that are similar to the embodiments shown in FIGS. 1-5. Therefore common features, functions, and elements may not be redundantly described here.

When the CPU 100 executes an application to play a video by a user's operation, a search screen shown in FIG. 4A is displayed on the first display screen 11a1, and a plurality of input key buttons is displayed on the second display screen 21a1 (Task S101). A search button and a text box in which letters are entered are displayed on the search screen.

When a user presses/activates an input key, a letter corresponding to the pressed input key is entered in the text box. Then, when the user presses/activates, the search, button, a video file located in a specific server or on internet is retrieved according to the letter string entered in the text box as a keyword (Task S102: YES).

The video related to the keyword is retrieved, and a frame and the accompanying data of the image data among the information of the retrieved video are taken in through the communication module 304. Then, the frame is displayed as the thumbnail image, and the accompanying data is displayed as the detailed information. As show in FIG. 4B, the search result list including the videos A to F is displayed on both display screen 11a1 and 21a1 (Task S103). The thumbnail images, “Images A to F,” corresponding to six videos of the videos A to F and the detailed information are displayed in the search result list. When there are more than six videos in the search result, a user performs an upward/downward flick operation or slide operation on the respective display screens 11a1 and 21a1 with his finger, and as, a result, the thumbnail images and the detailed information move toward the direction in which the finger moves. Hence, the other thumbnail images and detailed information of the videos are displayed, and the user is able to see the entire search result list.

When a user taps the thumbnail image, “Image B” or the detailed information of the video B in the search result list, the corresponding video B is selected (Task S104: YES). Thus, while the entire image data and the audio data of the video B are downloaded, the video B is played (Task S105). When the video B is played as illustrated in FIG. 5A, the image of the video B are displayed on the first display screen 11a1 based on the image data, and the sound is output from the speaker 308 based on the audio data. The downloaded image data and audio data are temporarily stored in the memory 200, but the data is deleted when the video is finished playing.

In addition, as illustrated in FIG. 5A, the search result list is displayed in the first display area 21b1 and the playlist is displayed on the second display area 21b2 on the second display screen 21a1 (Task S106). The thumbnail images and the detailed information displayed in the search result list also move by a user's flick and slide operation.

When a user touches on the thumbnail image, “Image D” in the search result list, the thumbnail image, “Image D” is selected (Task S107: YES). When the user sets the video corresponding to the selected thumbnail image as a play item in a playlist, he/she slides his/her finger to the playlist displayed in the second display area 21b2 on the second display screen 21a1 while maintaining a touch on the second display screen 21a1 (Task S108: YES). Hence, the title name, “Title D,” is extracted from the accompanying data of the video D, which is corresponding to the thumbnail image, “Image D.” The title name, “Title D,” is set as the play item, “Title D,” and the play item, “Title D,” is displayed in the playlist on the second display area 21b2. At this time, the frame for the thumbnail image, “Image D,” and the frame for the play item, “Title D,” of the video D are displayed with the thick line in the same color (Task S 109). These frames indicate that the thumbnail image, “Image D,” and the play item, “Title D,” are associated.

On the other hand, when the user prefers to play the video corresponding to the selected thumbnail image nearly immediately instead of listing it in the playlist, he/she does not slide his/her finger to the playlist displayed on the second display area 21b2 (Task S108: NO). In this case, after touching on the thumbnail image, “Image D,” the user can move his finger to the first display screen 11a1, continuously touches twice on the thumbnail image, “Image D,” or keeps touching on the thumbnail image, “Image D,” with his finger for more than the predefined time. Herewith, the video D corresponding to the thumbnail image, “Image D,” is specified as the item to be played. Then, the information of the video D is downloaded.

At this time, if a video is not being played (Task S110: NO), the video D is played (Task S111). On the other hand, if a video is being played (Task S110: YES), the playback of the video is terminated, and the video D is played (Task S112).

After the video D starts to play, the CPU 100 monitors the selection of the thumbnail images (Task S107). When a thumbnail image is not selected (Task S107: NO), if a video is being played (Task S113: YES) or if the next play item is not listed in the playlist on the second display area 21b2, the CPU 100 continues to monitor the selection of the thumbnail images (Task S107). On the other hand, if the video is finished playing (Task S113: YES) and if the next play item is listed (Task S 114: YES), the video corresponding to the play item starts to play (Task S115). When the video corresponding to the play item is played, the play item disappears.

Thus, according to the present embodiment, a user may set up an order of videos to be played by arranging play items in the playlist.

Specifically, by sliding a finger touching on a thumbnail image in the search result list displayed on the first display area 21b1 to the playlist displayed on the second display area 21b2, a user is easily able to list a play item in the playlist.

In the search result list, the thumbnail images and the detailed information are displayed, and a user is suitably able to select a desired video based on the information.

Moreover, according to the present embodiment, in which a play item is set up with text data, the CPU 100 bears less burden to process data compared to the case in which the play item is set up with an image (for example, a thumbnail image).

In addition, because the same marks are attached to the play item and the thumbnail image, it is intuitively understood that the play item and the thumbnail image are corresponding. Thus, by reference to the thumbnail image corresponding to the play item, a user easily grasps the video which the play item indicates.

In the above embodiment, the video is displayed on the screen shown in FIG. 5; however a still image, such as a picture, may be also displayed. In this case, still images are displayed in series in order of the play items.

In addition, in the embodiment described above, the images taken from the Internet or the predefined server through the communication module 304 are displayed as a search result list. On the other hand, the images read from the memory 200 in the mobile phone 1 may be displayed as an image list. In this case, specific images in the memory 200 are retrieved and the retrieved images may be displayed as a list, but all images in the memory 200 may also be displayed as a list.

Moreover, in the embodiment described above, the mobile phone 1 includes the first display screen 11a1 and the second display screen 21a1; however, the mobile phone 1 may include one or more, than three display screens.

In the embodiment described above, a video is displayed on the first display screen 11a1, and a search result list and a play list are displayed on the second display screen 21a1. Areas on which the video, the search result list, and the playlist are displayed are not limited to the first display screen 11a1, and the second display screen 21a1. For example, when only one display screen is exposed outside like the mobile phone 1 in the closed state, a video, a search result list, and a playlist are all displayed on a display screen. In this case, displaying these images on a display screen at the same time is possible, but instead, only a video may be displayed, and a search result list and a playlist may be displayed only during user operation.

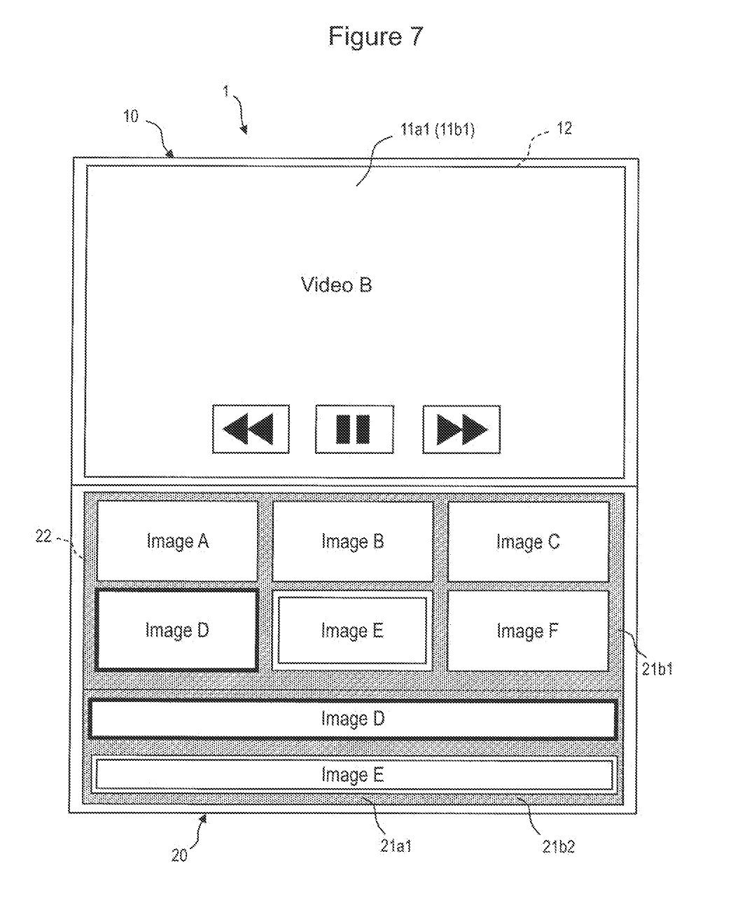

Additionally, in the embodiment described above, thumbnail images and detailed information are displayed as a search result list; however, as illustrated in FIG. 7, only thumbnail images may be displayed.

In the embodiment described above, thumbnail images, detailed information, and play items are vertically arranged, but the direction of the arrangement is not limited to this vertical arrangement. For example, as illustrated in FIG. 7, thumbnail images may be arranged horizontally.

In addition, in the embodiment described above, the search result and the playlist are arranged horizontally, but as illustrated in FIG. 7, a search result list and a playlist may be arranged vertically. Thus, even when a thumbnail image and a play item are arranged apart, the corresponding relationship of the thumbnail image and the play item, are easily recognizable by a mark, such as a color or a shape. Thumbnail images and play items may also be freely arranged according to a user's intention. Because a size of a thumbnail image and a play item may also be determined freely, the smaller the size becomes, the more information may be displayed.

Furthermore, in the embodiment described above, when a video corresponding to a play item is played, the play item disappears from the playlist. In contrast, when a finger touches on a play item for more than the predefined time, a message to delete the play item, such as an X mark or a comment of deletion, may be displayed. In this case, when the message is selected, the play item is deleted. All play items may also be deleted when the function to play videos is terminated.

In the above embodiment, the mobile phone 1 may be configured to temporarily interrupt a playback of a video and to output a ringtone from the speaker 308 when it receives a phone call or an e-mail while playing a video.

In this document, the terms “computer program product”, “computer-readable medium”, and the like may be used generally to refer to media such as for example, memory, storage devices, or storage unit These and other forms of computer-readable media may be involved in storing one or more instructions for use by the CPU 100 to cause the CPU 100 to perform specified operations. Such instructions, generally referred to as “computer program code” or “program code” (which may be grouped in the form of computer programs or other groupings), when executed, enable a method of using a system.

Terms and phrases used in this document, and variations hereof, unless otherwise expressly stated, should be construed as open ended as opposed to limiting. As examples of the foregoing: the term “including” should, be read as mean “including, without limitation” or the like; the term “example” is used to provide exemplary instances of the item in discussion, not an exhaustive or limiting list thereof; and adjectives, such as “conventional,” “traditional,” “normal,”, “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile terminal device, comprising:
a memory module operable to store an image and text data associated with the image;
a receiving module operable to receive an input to select the image;
a display module comprising a first display area and a second display area different from the first display area; and
a display control module operable to control the display module such that, when a selected thumbnail image of the image is displayed on the first display area, the text data associated with the selected thumbnail image is displayed on the second display area.

2. The mobile terminal device according to claim 1, wherein the display control module is further operable to allow the display module to display respectively a mark to the text data and the selected thumbnail image corresponding to the text data for indicating that the text data and the selected thumbnail image are associated with each other.

3. The mobile terminal device according to claim 2, wherein the mark comprises at least one of a color and a shape.

4. The mobile terminal device according to claim 1, wherein the display control module is further operable to allow the display module to display the text data on the second display area in an order in which the selected thumbnail image is selected.

5. The mobile terminal device according to claim 1, wherein the image comprises at least one of a still image and a video.

6. The mobile terminal device according to claim 1, wherein the display control module is further operable to allow the display module to display the selected thumbnail image and accompanying information of the image comprising the text data.

7. The mobile terminal device according to claim 1, wherein:
the display module further comprises a third display area different from the first display area and the second display area, and
the display control module is further operable to allow the display module to display the image that is displayed on the second display area and is associated with the text data, on the third display area at a size larger than the selected thumbnail image displayed on the first display area.

8. The mobile terminal device according to claim 7, wherein the display control module is further operable to allow the display module to display at least the image on the third display area according to an order of the text data displayed on the second display area.

9. The mobile terminal device according to claim 8, wherein:
the display module further comprises a first display module and a second display module;
the receiving module comprises a first receiving module receiving a first input to the first display module and a second receiving module receiving a second input to the second display module; and
the display control module is further operable to display the image on the third display area of the first display module, the selected thumbnail image on the first display area of the second display module and the text data on the second display area of the second display module.

10. A method for operating a mobile terminal device, the method comprising:
storing an image and text data associated with the image;
controlling a display module comprising a first display area and a second display area different from the first display area to display the image and the text data;
receiving an input to select the image to provide a selected image; and
displaying the text data on the second display area, when a thumbnail image of the selected image is displayed on the first display area.

11. The method according to claim 10, further comprising displaying respectively a mark to the text data and the selected thumbnail image corresponding to the text data for indicating that the text data and the selected thumbnail image are associated with each other.

12. The method according to claim 11, wherein the mark comprises at least one of a color and a shape.

13. The method according to claim 10, further comprising displaying the text data on the second display area in an order in which the selected thumbnail image is selected.

14. The method according to claim 10, wherein the image comprises at least one of a still image and a video.

15. The method according to claim 10, further comprising displaying the selected thumbnail image and accompanying information of the image comprising the text data.

16. The method according to claim 10, further comprising displaying the image that is displayed on the second display area and is associated with the text data on a third display area at a size larger than the selected thumbnail image displayed on the first display area, wherein the display module further comprises the third display area and the third display area is different from the first display area and the second display area.

17. The method according to claim 16, further comprising displaying at least one image on the third display area according to an order of the text data displayed and listed on the second display area, when at least two images and text data are displayed on the second display area.

18. The method according to claim 17, further comprising:
receiving a first input on a first display module;
receiving a second input on a second display module; and
displaying the image on the third display area of the first display module, the selected thumbnail image on the first display area of the second display module, and the text data on the second display area of the second display module.

19. A computer readable storage medium comprising computer-executable instructions for operating a mobile terminal device, the method executed by the computer-executable instructions comprising:
storing an image and text data associated with the image;
controlling a display module comprising a first display area and a second display area different from the first display area to display the image and the text data;
receiving an input to select the image to provide a selected image; and
displaying the text data on the second display area, when a selected thumbnail image of the selected image is displayed on the first display area.

20. The computer readable storage medium according to claim 19, the method executed by the computer-executable instructions further comprising displaying respectively a mark to the text data and the selected thumbnail image corresponding to the text data for indicating that the text data and the selected thumbnail image are associated with each other.
